(19) United States
(12) Patent Application Publication
(10) Pub. No.: US 2016/0170840 A1
(43) Pub. Date: Jun. 16, 2016

(54) VEHICLE INFORMATION BACKUP UNIT FOR STORING INFORMATION OF TELEMATICS UNIT, MOBILE TERMINAL, AND VEHICLE INFORMATION BACKUP SYSTEM

(71) Applicant: Hyundai Motor Company, Seoul (KR)

(72) Inventor: Sung Wook Heo, Yongin (KR)

(21) Appl. No.: 14/945,270

(22) Filed: Nov. 18, 2015

(30) Foreign Application Priority Data
Dec. 15, 2014 (KR) 10-2014-0180217

(51) Int. Cl. G06F 11/14

(52) U.S. Cl. CPC G06F 11/1464; G06F 2201/84

(57) ABSTRACT

A vehicle information backup unit is disclosed. The vehicle information backup unit may be connected to a first telematics unit, store at least one information item received from the first telematics unit through in-vehicle communication, and configured to make a backup of the at least one information in response to a preset event.

### CROSS-REFERENCE TO RELATED APPLICATION

This application claims the benefit of and priority to Korean Patent Application No. 10-2014-0180217, filed on Dec. 15, 2014, which is hereby incorporated by reference in its entirety as if fully set forth herein.

### BACKGROUND OF THE DISCLOSURE

1. Technical Field

The present disclosure relates generally to a vehicle information backup unit for storing information of a telematics unit, a mobile terminal, and a vehicle information backup system and, more particularly, to a vehicle information backup unit for storing information included in a telematics unit before the telematics unit is replaced, a mobile terminal, and a vehicle information backup system.

2. Discussion of the Related Art

Due to rapid development of electronic control technologies, a variety of devices which have traditionally been mechanically operated in a car can now be electrically driven for added convenience and safety. In this regard, telematics is a service for transmitting and receiving information using a computer embedded in transportation equipment, such as a vehicle, an airplane, or a vessel, and for using wireless communication technology, a satellite navigator, text-to-voice or voice-to-text conversion technology on the Internet, etc. The term “telematics” is a compound word consisting of telecommunication and informatics, and refers to a system equipped to analyze various situations occurring in a vehicle, to collect various types of information necessary for driving, and thus to achieve more convenient and safe driving, using a communication terminal mounted in the car.

To receive a telematics service, a global positioning system (GPS) and a telematics unit having a mobile communication function should be mounted in a vehicle. The typical telematics service provides, for example, vehicle accident information, stolen vehicle detection, and game services to a driver by combining mobile communication technology and location tracking technology to a car. In addition, the telematics unit stores user information, setting information, etc.

Conventional telematics technology utilizes a method for making a backup of volatile data stored in dynamic random-access memory (DRAM), in a non-volatile storage medium when power of a device is cut off, and then restoring the data thereafter. However, a technology for more efficiently protecting and making a backup of information included in a telematics unit when the telematics unit is replaced is needed.

### SUMMARY OF THE DISCLOSURE

Accordingly, the present disclosure is directed to a vehicle information backup unit for storing information of a telematics unit, a mobile terminal, and a vehicle information backup system which substantially obviate one or more problems due to limitations and disadvantages of the related art.

An object of the present disclosure is to provide a vehicle information backup unit of a vehicle, a mobile terminal, and a vehicle information backup system for autonomously making a backup of information included in a telematics unit of the vehicle before the telematics unit is replaced, and using the backup information to update a new telematics unit. Another object of the present disclosure is to provide a mobile terminal and a vehicle information backup system for making a backup of information included in a telematics unit of a vehicle before the vehicle is replaced, and using the backup information to update a telematics unit of a new vehicle.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a vehicle information backup unit is connected to a first telematics unit, stores at least one information item received from the first telematics unit through in-vehicle communication, and configured to make a backup of the at least one information in response to a preset event.

The vehicle information backup unit may be further configured to transmit backup information of the backup to a second telematics unit in response to another preset event when the first telematics unit is replaced with the second telematics unit.

The vehicle information backup unit may be an audio/video/navigation (AVN) terminal.

The vehicle information backup unit may include at least one of telematics service open information, vehicle owner information, vehicle diagnosis information, and vehicle setting information.

The vehicle setting information may include setting information related to functional devices and multimedia devices mounted in a vehicle.

The vehicle information backup unit may be further configured to receive the at least one information item from the first telematics unit and make a backup of the information in real-time or in a cycle of a preset time.

The preset event may include one or more of manipulation of pressing a specific button of the vehicle information backup unit and manipulation through a specific voice command.

Furthermore, according to embodiments of the present disclosure, a vehicle information backup unit includes: a communication unit communicating with a first telematics unit; an information storage unit storing information received from the first telematics unit; and a controller making a backup of the information received from the first telematics unit in response to a preset event.

The information storage unit may store at least one of telematics service open information, vehicle owner information, vehicle diagnosis information, and vehicle setting information, received from the first telematics unit.

Furthermore, according to embodiments of the present disclosure, a mobile terminal for making a backup of information of a telematics unit includes: a communication unit receiving information of a telematics unit mounted in a first vehicle, from the first vehicle; an information storage unit storing the received information; and a controller controlling the communication unit so as to transmit the stored information to a second vehicle.

The controller may receive vehicle identification number (VIN) information of the first vehicle and user information of the first vehicle, from the first vehicle.

The controller may transmit the VIN information of the first vehicle and the user information of the first vehicle to a telematics center.

The controller may receive at least one information item from the first vehicle and make a backup of the at least one information item in real-time or in a cycle of a preset time.

Furthermore, according to embodiments of the present disclosure, a vehicle information backup system includes: a mobile terminal receiving information of a telematics unit mounted in a first vehicle, from the first vehicle, and storing the received information; and a telematics center receiving vehicle identification number (VIN) information and user information from the mobile terminal, comparing pre-registered information to the received information, and providing telematics service to a second vehicle when the pre-registered information corresponds to the received information.

Furthermore, according to embodiments of the present disclosure, a vehicle information backup system includes: a mobile terminal receiving information of a telematics unit mounted in a first vehicle, from the first vehicle, and storing the received information; and a telematics center receiving the information of the telematics unit from the mobile terminal, making a backup of the received information, and transmitting service information of the received information to a second vehicle.

The service information may include service open information or vehicle owner information.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a schematic diagram of a backup system according to embodiments of the present disclosure;

FIG. 2 is a diagram exemplarily showing in-vehicle communication performed using controller area network (CAN) communication, according to embodiments of the present disclosure;

FIG. 3 is a block diagram of a vehicle information backup unit according to embodiments of the present disclosure;

FIG. 4 is a flowchart of a method for controlling the vehicle information backup unit, according to embodiments of the present disclosure;

FIG. 5 is a flowchart of a method for controlling a mobile terminal for making a backup of vehicle information when a vehicle is replaced, according to embodiments of the present disclosure; and

FIG. 6 is a diagram showing operation of the mobile terminal for making a backup of the vehicle information when the vehicle is replaced.

### DETAILED DESCRIPTION OF THE DISCLOSURE

Reference will now be made in detail to embodiments of the present disclosure, examples of which are illustrated in the accompanying drawings. Like reference numerals in the drawings denote like elements and repeated descriptions thereof will be omitted. The suffixes “module”, “-er/or” and “unit” of elements herein are used for convenience of description and thus can be used interchangeably and do not have any distinguishable meanings or functions. In the following description of the present disclosure, a detailed description of known functions and configurations incorporated herein will be omitted when it may make the subject matter of the present disclosure unclear. It should be understood that there is no intent to limit embodiments of the disclosure to the particular forms disclosed; rather, embodiments of the disclosure are to cover all modifications, equivalents, and alternatives falling within the spirit and scope of the disclosure.

The terms “first”, “second”, and the like, herein do not denote any order, quantity, or importance, but rather are used to distinguish one element from another. It will be understood that when an element is referred to as being “connected to” or “coupled to” another element, it can be directly connected or coupled to the other element or intervening elements may be present therebetween. In contrast, when an element is referred to as being “directly connected to” or “directly coupled to” another element, no intervening elements are present.

As used herein, the singular forms “a”, “an” and “the” are intended to include the plural forms as well, unless the context clearly indicates otherwise. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

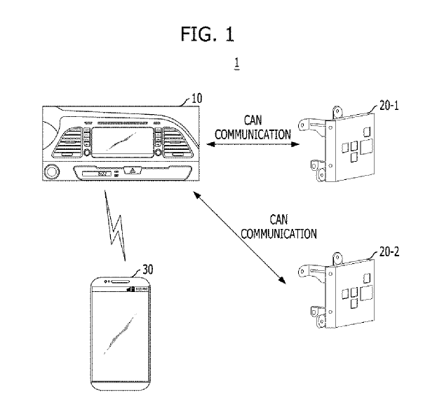

Referring now to the disclosed embodiments, FIG. 1 is a schematic diagram of a backup system 1 according to embodiments of the present disclosure.

As shown in FIG. 1, the backup system 1 according to embodiments of the present disclosure may include a vehicle information backup unit 10, a first telematics unit 20-1, a second telematics unit 20-2, and a mobile terminal 30.

If the first telematics unit 20-1 is broken and thus replaced with the second telematics unit 20-2, the backup system 1 may make a backup of information included in the first telematics unit 20-1, in the vehicle information backup unit 10. Thereafter, if the second telematics unit 20-2 is mounted in a vehicle, the backup system 1 may update the second telematics unit 20-2 based on the information stored in the vehicle information backup unit 10 using in-vehicle communication.

The present disclosure may provide user added convenience as compared to a conventional technology by which necessary information is reset in the second telematics unit 20-2 by a telematics center (not shown) when the first telematics unit 20-1 is replaced with the second telematics unit 20-2.

The vehicle information backup unit 10 may be a head unit. However, the vehicle information backup unit 10 is not limited to an audio/video/navigation (AVN) terminal, and may be any of a variety of terminals. Particularly, the vehicle information backup unit 10 may store the backup information in a separate storage.

For demonstration purposes only, the vehicle information backup unit 10 is assumed to be an AVN terminal in this specification.

The vehicle information backup unit 10 may provide a variety of multimedia access services such as radio broadcasting (FM/AM), digital multimedia broadcasting (DMB), digital audio radio service (DARS), and Wi-Fi, and may receive an audio or video signal and provide the same to the vehicle through a display or a speaker. The vehicle information backup unit 10 may transmit and receive data to and from the first or second telematics unit 20-1 or 20-2 through controller area network (CAN) communication.

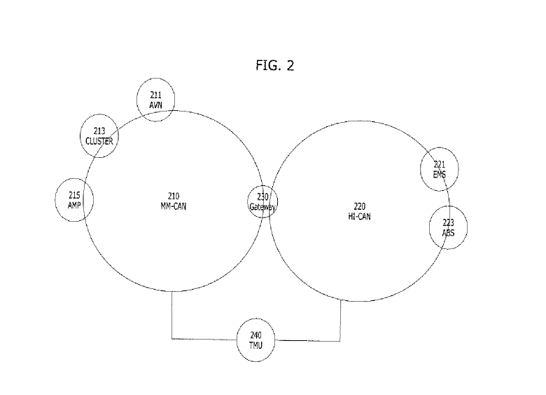

A detailed description thereof will be given below with reference to FIG. 2.

The first or second telematics unit 20-1 or 20-2 may receive a remote control command such as a remote start command, a remote air-conditioning command, or a remote vehicle door lock/unlock command from a telematics center (not shown)and perform an operation corresponding thereto. The first or second telematics unit 20-1 or 20-2 includes a modem for communicating with a mobile communication center or the telematics center. The first or second telematics unit 20-1 or 20-2 includes a memory therein. The memory may store telematics center information, vehicle information, user information, setting information, etc.

The first telematics unit 20-1 includes all of the above information items. However, when the first telematics unit 20-1 is replaced with the second telematics unit 20-2, the vehicle information backup unit 10 may request the information stored in the first telematics unit 20-1, from the first telematics unit 20-1.

In this case, if the second telematics unit 20-2 is mounted in the vehicle after the vehicle information backup unit 10 receives the information from the first telematics unit 20-1, the second telematics unit 20-2 may be updated using the information stored in the vehicle information backup unit 10. Meanwhile, the mobile terminal 30 may request the information included in the first telematics unit 20-1, from the vehicle information backup unit 10, and receive and store this information. The mobile terminal 30 may receive the information from the vehicle information backup unit 10 using, for example, BT/Wi-Fi.

If the information is stored in the mobile terminal 30, the mobile terminal 30 constantly has the information of the first telematics unit 20-1 even when the vehicle is replaced. The mobile terminal 30 may be connected to a vehicle information backup unit (not shown) of a new vehicle, and then use the information for a telematics unit of the new vehicle.

FIG. 2 is a diagram exemplarily showing in-vehicle communication performed using CAN communication, according to embodiments of the present disclosure.

As shown in FIG. 2, a vehicle may perform CAN communication for in-vehicle communication. The vehicle may classify a plurality of electronic control units (ECUs) into a plurality of categories. The CAN communication provides message transmission and reception among a plurality of CAN buses.

Examples of the CAN bus may include a powertrain (P)-CAN, a chassis (C)-CAN, a body (B)-CAN, and a multimedia (MM)-CAN. The P-CAN, the C-CAN, the B-CAN, or the like corresponds to a high speed (Hi)-CAN.

As illustrated in FIG. 2, an MM-CAN 210 may include an AVN 211, a cluster 213, an amplifier (AMP) 215, etc. The MM-CAN 210 refers to a CAN related to multimedia. In addition, a Hi-CAN 220 may include an engine management system (EMS) 221, an anti-lock braking system (ABS) 223, etc. The Hi-CAN 220 may further include a variety of constituent ECUs other than the EMS 221 and the ABS 223.

A telematics unit (TMU) 240 may be connected to both the MM-CAN 210 and the Hi-CAN 220.

A gateway 230 routes messages between CAN buses. For example, when the AVN 211 transmits a message through the MM-CAN 210 to the EMS 221, the gateway 230 may control the message to be appropriately transmitted to the EMS 221.

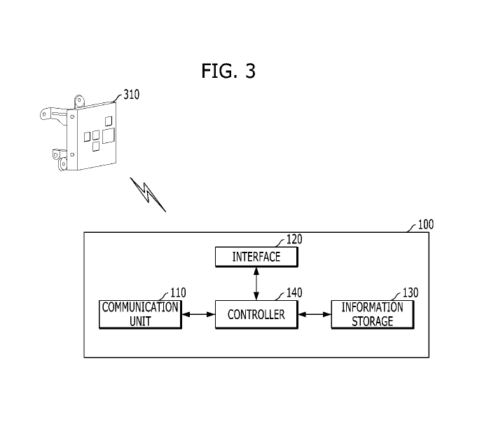

FIG. 3 is a block diagram of a vehicle information backup unit 100 according to embodiments of the present disclosure.

As shown in FIG. 3, the vehicle information backup unit 100 may communicate with a telematics unit 310. The vehicle information backup unit 100 is assumed to be an AVN terminal. However, an information storage 130 of the vehicle information backup unit 100 may be separate from the vehicle information backup unit 100.

The vehicle information backup unit 100 may include a communication unit 110, an interface 120, the information storage 130, and a controller 140.

The communication unit 110 may communicate with various devices inside a vehicle, an electronic control unit (ECU) of the vehicle, and an external device under control of the controller 140. For example, the communication unit 110 may communicate with the telematics unit 310 using Bluetooth, Wi-Fi, or the like.

The interface 120 is an element communicably connected to devices inside/outside the vehicle. For example, when a universal serial bus (USB) cable is connected to the vehicle information backup unit 100, the interface 120 may transmit data under control of the controller 140.

The information storage 130 may store programs for operation, and temporarily store input/output data (e.g., messages and commands). The information storage 130 may store data related to various patterns of vibration and sound output from the vehicle. The information storage 130 may include at least one storage medium selected from among a flash memory, a hard disk, a solid state disk (SSD), a silicon disk drive (SDD), a multimedia card micro, a card memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. In addition, the information storage 130 may be provided outside the vehicle information backup unit 100.

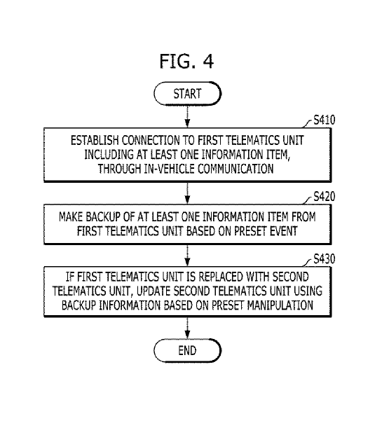

The information storage 130 may store information of the telematics unit 310. A description of fields of the information stored by the information storage 130 will be given below with reference to FIG. 4.

Meanwhile, the telematics unit 310 may communicate with a telematics center (not shown). The telematics unit 310 may include a modem (not shown), a memory (not shown), etc.

FIG. 4 is a flowchart of a method for controlling the vehicle information backup unit 100, according to embodiments of the present disclosure.

The vehicle information backup unit 100 is connected to a first telematics unit including at least one information item, through in-vehicle communication (S410). The controller 140 performs in-vehicle communication with the first telematics unit through the communication unit 110 or the interface 120. For example, the controller 140 may communicate with the first telematics unit using CAN communication or media-oriented system transport (MOST) communication. Alternatively, the controller 140 may communicate with the first telematics unit using a USB, a serial bus, or the like.

The controller 140 may receive at least one information item from the first telematics unit. This information may include user information including vehicle owner information, unit setting information (e.g., setting information related to functional devices and multimedia devices mounted in a vehicle), telematics service open information, information received through paid services by a user, center access information (e.g., IP, SMS, call transmission/reception number), vehicle diagnosis information, payment system information, geofence setting information, speed alert setting information, vehicle identification number (VIN) diagnosis target list information, etc.

Thereafter, the controller 140 may make a backup of the above information from the first telematics unit in response to a preset event (S420). The preset event may be, for example, software (S/W) key input or voice command input for requesting the information. If the preset event occurs, the controller 140 may request the first telematics unit to transmit the information.

The controller 140 may receive the above information through the communication unit 110 or the interface 120 and may store the above information in the information storage 130 as a backup. In addition, the controller 140 may request the above-described information from the first telematics unit in real-time or in a cycle of a preset time. In this case, if the first telematics unit is unexpectedly broken, the controller 140 may store the information included in the first telematics unit. As such, user convenience and device usability and efficiency may be improved.

Thereafter, if the first telematics unit is replaced with a second telematics unit, the controller 140 updates the second telematics unit using the backup information in response to a preset event, such as manipulation including S/W key input or voice command input (S430).

The second telematics unit may be similar to the first telematics unit in external appearance, but does not initially include the above-described information included in the first telematics unit. The controller 140 may transmit the backup information stored in the vehicle information backup unit 100 to the second telematics unit in response to the manipulation such as S/W key input or voice command input.

The present disclosure may reduce conventional inconvenience that user information, telematics unit setting information, etc. should be received from a telematics center if a telematics unit is replaced. As such, user convenience may be improved, and improvement of device efficiency is expected.

The controller 140 updates the second telematics unit based on the information transmitted to the second telematics unit (S440). The second telematics unit may be unit-updated based on the received information. In this case, information such as user information, unit setting information, paid application, recent vehicle diagnosis history information, payment system information, geofence setting information, speed alert setting information, and vehicle VIN diagnosis target list information may be conveniently used.

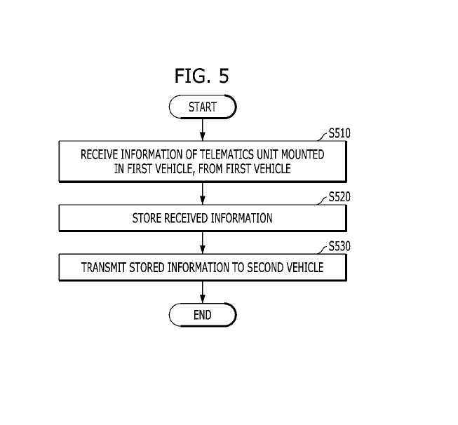

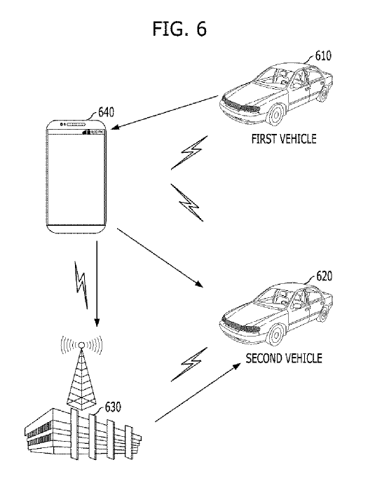

FIG. 5 is a flowchart of a method for controlling a mobile terminal for making a backup of vehicle information when a vehicle is replaced, according to embodiments of the present disclosure. FIG. 6 is a diagram showing operation of the mobile terminal for making a backup of the vehicle information when the vehicle is replaced. The method of FIG. 5 is now described in conjunction with FIG. 6.

A mobile terminal 640 receives information of a telematics unit mounted in a first vehicle 610, from the first vehicle 610 (S510). The information of the telematics unit includes the above-described information. In addition, the mobile terminal 640 may receive VIN information and user information of the first vehicle 610 from the first vehicle 610. That is, the mobile terminal 640 may receive vehicle-identifiable information from the first vehicle 610.

Thereafter, the mobile terminal 640 stores the received information (S520). The mobile terminal 640 may receive the information from the first vehicle 610 using Bluetooth, Wi-Fi, or USB communication and store the same in memory. In addition, the mobile terminal 640 may receive the information from the first vehicle 610 via a telematics center 630 and store the same. The mobile terminal 640 may receive and make a backup of at least one information item in real-time or in a cycle of a preset time. As such, the mobile terminal 640 may efficiently protect and manage the information.

Thereafter, the mobile terminal 640 transmits the stored information to the second vehicle 620 (S530). In this case, the mobile terminal 640 may transmit the stored information to a telematics unit of the second vehicle 620 directly or via the telematics center 630. In this case, the telematics center 630 may compare pre-registered information to the received information and allow telematics service to the second vehicle 620 if the pre-registered information equals the received information. Then, the second vehicle 620 may update information of the telematics unit using the received information.

In addition, when a user gets in the second vehicle 620 while carrying the mobile terminal 640 including the above information, the telematics unit of the second vehicle 620 may transmit VIN information of the second vehicle 620 and a unique ID of the user to the telematics center 630 once. As such, the user may use the telematics unit of the second vehicle 620 in the same environment as the first vehicle 610.

Although the above description is focused on a case in which a telematics unit is replaced with a new one, the principle of the present disclosure is also applicable to a case in which various in-vehicle units including a seat control unit is replaced. For example, if setting information of a certain unit (e.g., user-preferred seat setting information of the seat control unit) is stored in another unit such as a vehicle information backup unit and then a new unit is mounted, the new unit may be updated using the setting information.

Furthermore, a vehicle information backup system according to embodiments of the present disclosure includes the mobile terminal 640 for receiving information of the telematics unit mounted in the first vehicle 610, from the first vehicle 610, and storing the received information, and the telematics center 630 for receiving the information of the telematics unit from the mobile terminal 640 and making a backup thereof, and the telematics center 630 may transmit service information included in the received information, which is equally applicable to the second vehicle 620, to the second vehicle 620.

Here, the service information equally applicable to the second vehicle 620 may include, for example, service open information or vehicle owner information. In addition, the telematics center 630 may transmit a part of vehicle setting information, which is applicable to the second vehicle 620, (e.g., multimedia setting information), to the second vehicle 620.

The telematics center 630 may not apply information not equally applicable to the second vehicle 620 (e.g., function setting information and information dependent on the first vehicle 610), to the second vehicle 620, and may selectively determine and transmit information applicable to the second vehicle 620, to the second vehicle 620. Various types of information not mentioned or described in this specification may also be included.

As is apparent from the above description, according to various embodiments of the present disclosure, when a telematics unit of a vehicle is replaced, since a backup of information included in the telematics unit is autonomously made and used to update a new telematics unit, user convenience may be improved. Furthermore, when a telematics unit is replaced, since information included in the telematics unit may be used to update a new telematics unit without connection to a telematics center, device efficiency and device usability may be improved. In addition, when a vehicle including a telematics unit is replaced, since a backup of information included in the telematics unit of the vehicle may be made and used to update a telematics unit of a new vehicle, user convenience and device efficiency may be improved.

It will be appreciated by persons skilled in the art that the effects that could be achieved through the present disclosure are not limited to what has been particularly described hereinabove and other advantages of the present disclosure will be more clearly understood from the above detailed description taken in conjunction with the accompanying drawings.

The present disclosure can also be embodied as computer-readable code on a computer-readable recording medium. The computer-readable recording medium is any data storage device that can store data which can be thereafter read by a computer system. Examples of the computer-readable recording medium may include a hard disk drive (HDD), a solid state disk (SSD), a silicon disk drive (SDD), ROM, RAM, a CD-ROM, a magnetic tape, a floppy disk, and an optical data storage device.

Accordingly, the above detailed description is not to be construed as limiting the present disclosure in all aspects and be considered by way of example. The scope of the present disclosure should be determined by reasonable interpretation of the accompanying claims and all equivalent modifications made without departing from the present disclosure should be included in the following claims.

What is claimed is:

1. A vehicle information backup unit that is connected to a first telematics unit, stores at least one information item received from the first telematics unit through in-vehicle communication, and configured to make a backup of the at least one information in response to a preset event.

2. The vehicle information backup unit according to claim 1, wherein the vehicle information backup unit is further configured to transmit backup information of the backup to a second telematics unit in response to another preset event when the first telematics unit is replaced with the second telematics unit.

3. The vehicle information backup unit according to claim 1, wherein the vehicle information backup unit is an audio/video/navigation (AVN) terminal.

4. The vehicle information backup unit according to claim 1, wherein the vehicle information backup unit includes at least one of telematics service open information, vehicle owner information, vehicle diagnosis information, and vehicle setting information.

5. The vehicle information backup unit according to claim 4, wherein the vehicle setting information includes setting information related to functional devices and multimedia devices mounted in a vehicle.

6. The vehicle information backup unit according to claim 1, wherein the vehicle information backup unit is further configured to receive the at least one information item from the first telematics unit and make a backup of the information in real-time or in a cycle of a preset time.

7. The vehicle information backup unit according to claim 1, wherein the preset event includes one or more of manipulation of pressing a specific button of the vehicle information backup unit and manipulation through a specific voice command.

8. A vehicle information backup unit comprising:
a communication unit communicating with a first telematics unit;
an information storage unit storing information received from the first telematics unit; and
a controller making a backup of the information received from the first telematics unit in response to a preset event.

9. The vehicle information backup unit according to claim 8, wherein the information storage unit stores at least one of telematics service open information, vehicle owner information, vehicle diagnosis information, and vehicle setting information, received from the first telematics unit.

10. A mobile terminal for making a backup of information of a telematics unit, the mobile terminal comprising:
a communication unit receiving information of a telematics unit mounted in a first vehicle, from the first vehicle;
an information storage unit storing the received information; and
a controller controlling the communication unit so as to transmit the stored information to a second vehicle.

11. The mobile terminal according to claim 10, wherein the controller receives vehicle identification number (VIN) information of the first vehicle and user information of the first vehicle, from the first vehicle.

12. The mobile terminal according to claim 10, wherein the controller transmits the VIN information of the first vehicle and the user information of the first vehicle to a telematics center.

13. The mobile terminal according to claim 10, wherein the controller receives at least one information item from the first vehicle and makes a backup of the at least one information item in real-time or in a cycle of a preset time.

14. A vehicle information backup system comprising:
a mobile terminal receiving information of a telematics unit mounted in a first vehicle, from the first vehicle, and storing the received information; and
a telematics center receiving vehicle identification number (VIN) information and user information from the mobile terminal, comparing pre-registered information to the received information, and providing telematics service to a second vehicle when the pre-registered information corresponds to the received information.

15. A vehicle information backup system comprising:
a mobile terminal receiving information of a telematics unit mounted in a first vehicle, from the first vehicle, and storing the received information; and
a telematics center receiving the information of the telematics unit from the mobile terminal, making a backup of the received information, and transmitting service information of the received information to a second vehicle.

16. The vehicle information backup system according to claim 15, wherein the service information includes service open information or vehicle owner information.
